(19) United States
(12) Patent Application Publication
(10) Pub. No.: US 2023/0023691 A1
(43) Pub. Date: Jan. 26, 2023

(54) FREE-FORM TEXT PROCESSING FOR SPEECH AND LANGUAGE EDUCATION

(71) Applicant: Sterten, Inc., Atlanta, GA (US)

(72) Inventors: Casey D. Knerr, Berlin, MD (US); Catherine L. Trense, Atlanta, GA (US); James C. Pavur, Atlanta, GA (US); Nancy M. Pavur, Atlanta, GA (US)

(21) Appl. No.: 17/378,911

(22) Filed: Jul. 19, 2021

(51) Int. Cl. G10L 15/01; G10L 15/26; G10L 25/51; G10L 15/22

(52) U.S. Cl. CPC G10L 15/01; G10L 15/26; G10L 25/51; G10L 15/22; G10L 2015/225

(57) ABSTRACT

Methods, systems, and computer-readable storage media for providing reading performance feedback to a user from a voice recording of the user reading an arbitrary text. A target text comprising a text passage that a user intends to read and a user recording comprising an audio recording of the user reading the target text aloud are received from a user device. The user recording is converted to a user speech hypothesis comprising text corresponding to speech recognized in the audio recording. The user speech hypothesis is then compared to the target text to generate reading performance feedback comprising relevant differences between the speech in the user recording and the target text and the reading performance feedback is displayed to the user on the user device.

### BRIEF SUMMARY

The present disclosure relates to technologies for providing reading performance feedback to a user from a voice recording of the user reading an arbitrary text. According to some embodiments, a method comprises receiving a target text comprising a text passage that a user intends to read and a user recording comprising an audio recording of the user reading the target text aloud. The user recording is converted to a user speech hypothesis comprising text corresponding to speech recognized in the audio recording. The user speech hypothesis is then compared to the target text to generate reading performance feedback comprising relevant differences between the speech in the user recording and the target text and the reading performance feedback is displayed to the user.

According to further embodiments, a computer-readable medium is encoded with processor-executable instructions that cause a computing system to, in response to receiving a target text from a user device comprising a text passage that a user of the user device intends to read, sanitizing the target text to produce a target ground truth, and, in response to receiving a user recording comprising an audio recording of the user reading the target text aloud, converting the user recording to a user speech hypothesis comprising text corresponding to speech recognized in the audio recording. The computing system then compares the user speech hypothesis to the target ground truth to generate reading performance feedback comprising relevant differences between the speech in the user recording and the target ground truth and sends the reading performance feedback to the user device for display to the user.

According to further embodiments, a system comprises a client app and a reading evaluation service. The client app is configured to execute on a user device and to receive a target text from a user of the user device, the target text comprising a text passage that the user intends to read. The client app utilizes audio recording resources of the user device to create a user recording comprising an audio recording of the user reading the target text aloud and transmits the target text and user recording to the reading evaluation service over one or more networks connecting the client app to the reading evaluation service. The reading evaluation service is configured to receive the target text and user recording from the client app, sanitize the target text to produce a target ground truth, and convert the user recording to a user speech hypothesis comprising text corresponding to speech recognized in the audio recording. The reading evaluation service then compares the user speech hypothesis to the target ground truth to generate reading performance feedback comprising relevant differences between the speech in the user recording and the target ground truth and transmits the reading performance feedback to the client app over the one or more networks. The client app receives the reading performance feedback from the reading evaluation service and displays the reading performance feedback to the user on the user device.

These and other features and aspects of the various embodiments will become apparent upon reading the following Detailed Description and reviewing the accompanying drawings.

### BRIEF DESCRIPTION OF THE DRAWINGS

In the following Detailed Description, references are made to the accompanying drawings that form a part hereof, and that show, by way of illustration, specific embodiments or examples. The drawings herein are not drawn to scale. Like numerals represent like elements throughout the several figures.

FIG. 1 is a system diagram showing an illustrative system in which a reading evaluation service may be implemented, according to embodiments presented herein.

FIG. 2 is a system diagram showing further details of software components of the reading evaluation system, according to embodiments presented herein.

FIGS. 3A-3C are GUI diagrams showing the display of a web-based client application for accessing a reading evaluation service, according to embodiments presented herein.

FIG. 4 is a flow chart showing a routine for providing reading performance feedback to a user from a voice recording of the user reading an arbitrary text, according to embodiments presented herein.

FIG. 5 is a block diagram showing an example computer architecture for computer(s) capable of executing the software components described herein.

### DETAILED DESCRIPTION

The following detailed description is directed to technologies for providing reading performance feedback to a user from a voice recording of the user reading an arbitrary text. A reading analysis and evaluation service may be made widely available that synchronizes arbitrary textual input with voice recordings of users attempting to read that input and provide feedback on reading speed, accuracy, and quality in order to facilitate speech and language education. In contrast with traditional speech-to-text technologies, the disclosed reading evaluation service addresses the specific and challenging problem of mapping audio input against a specific desired result in a context where that desired result is unknown to the software prior to the moment a user requests feedback.

The disclosed reading evaluation service can be employed in a variety of contexts. For example, a teacher who wishes to monitor their students' progress may leverage it to receive consistent and comparable scores across an entire class, allowing the teacher to identify and prioritize students who may be struggling with specific words or concepts. Likewise, it may be medically necessary to help adults re-develop speech capabilities following a traumatic brain injury or other incident. As a supplement to traditional speech therapy, this technology allows practitioners to monitor at-home speech exercises and to identify long-term trends and progress in their patients.

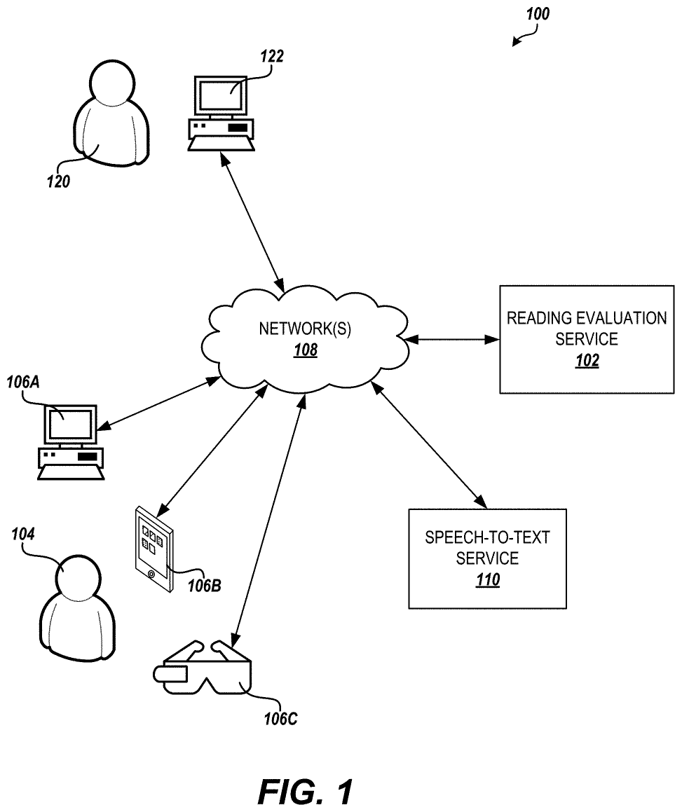

FIG. 1 shows an overview of an illustrative system 100 for implementation of a reading evaluation service 102, according to embodiments. As will be described herein, the reading evaluation service 102 provides reading performance feedback to a user 104 from a voice recording of the user reading an arbitrary text. In some embodiments, the reading evaluation service 102 may be implemented as a cloud-based computing system utilizing a combination of virtualized processing resources, communication resources, storage resources, and other cloud-based computing resources. The user 104 may utilize a personal computing device, such as a desktop or laptop computer 106A, a mobile device or table 106B, an augmented reality (“AR”) headset 106C, or the like (referred to herein generally as user device 106), to access the reading evaluation service 102 over one or more networks 108. The network(s) 108 may comprise any combination of Wi-Fi networks, LANs, WANs, cellular data networks, the Internet, and/or any other networking topology known in the art that connects the user device 106 to other, remote computers or computing resources.

As will be described in more detail below, the reading evaluation service 102 may utilize a third-party speech-to-text service 110 to process audio recordings of users 104 reading texts. According to embodiments, the reading evaluation service 102 is generally agnostic to the specific technologies used for the speech-to-text service 110. In some embodiments, the speech-to-text service 110 may comprise any cloud-based speech-to-text resources available to the reading evaluation service 102 over the network(s) 108. For example, the speech-to-text service 110 may comprise the Google Cloud Speech-to-Text service from Google, Inc., the Amazon Transcribe ASR service from Amazon Web Services, Inc., the Azure Speech service from Microsoft Corp., or the like. In alternative embodiments, the speech-to-text service 110 may represent a library or other software components and resources directly integrated in the reading evaluation service 102, such as the open-source CMUSphinx or Mozilla DeepSpeech libraries or the like.

The reading evaluation service 102 may further provide session summaries, evaluation results, and other information regarding multiple users 104 to associated educators/clinicians 120 utilizing educator/clinician computing devices 122, such as a desktop or laptop computer, to access the reading evaluation service over the network(s) 108.

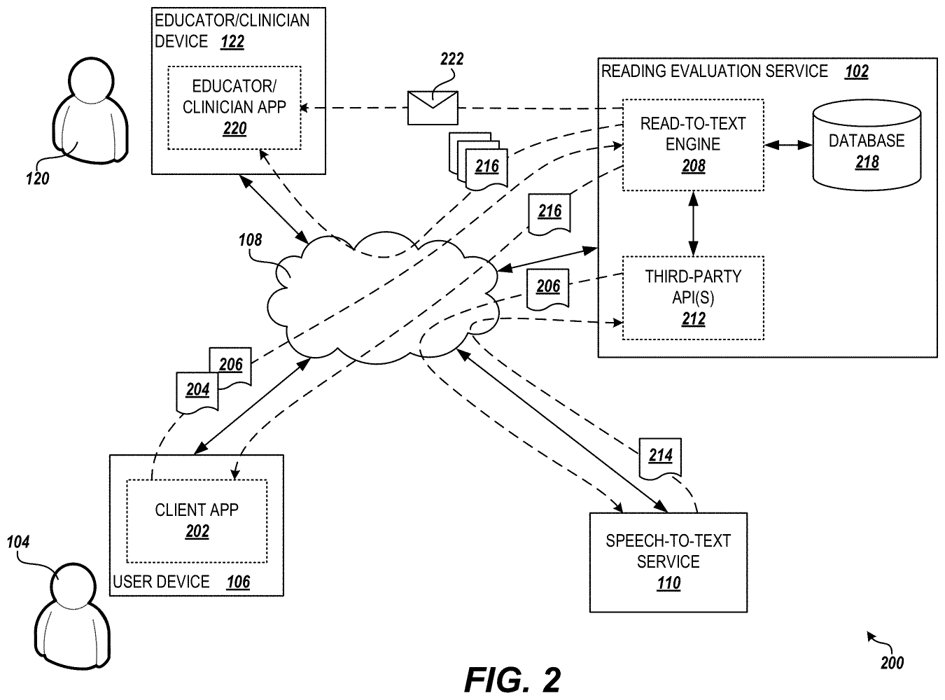

FIG. 2. shows additional details of illustrative hardware and software components of the system 100 incorporating the reading evaluation service 102. According to embodiments, the user 104 utilizes a client app 202 executing on the user device 106 to access the reading evaluation service 102. In some embodiments, the client app 202 may represent a web-based application, such as a JavaScript/ECMAScript application delivered to the user device 106 by the reading evaluation service 102 over the network(s) 108 and executing in a browser application of the device. The web-based application may be generated from a web front-end framework, such as the open-source VueJS framework. In further embodiments, the client app 202 may represent a mobile app downloaded to the user device 106 or client software installed and executing on the user device.

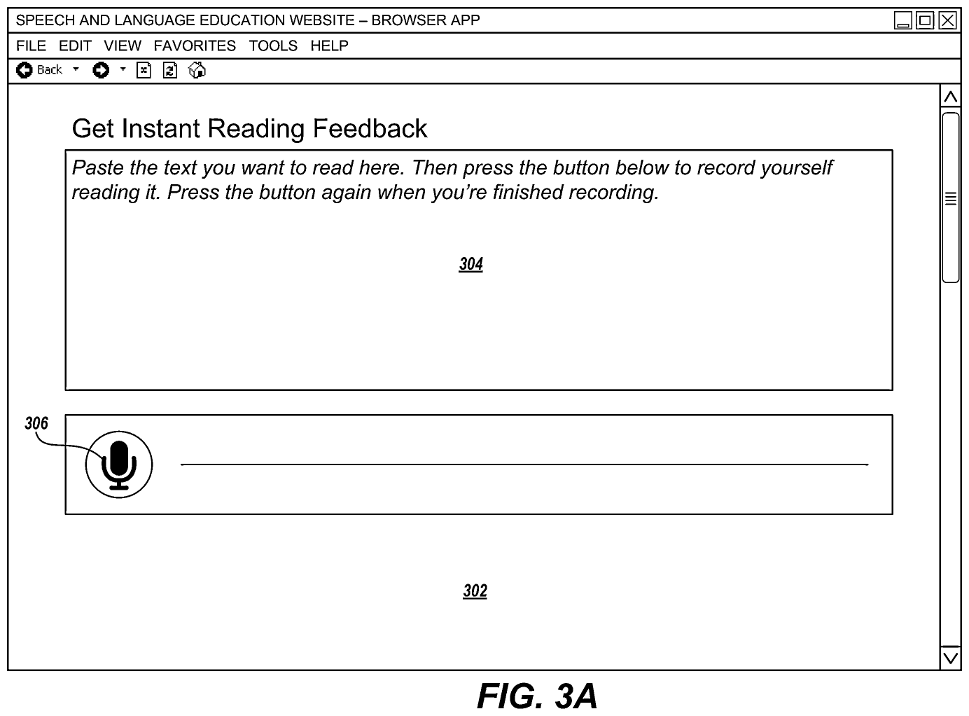

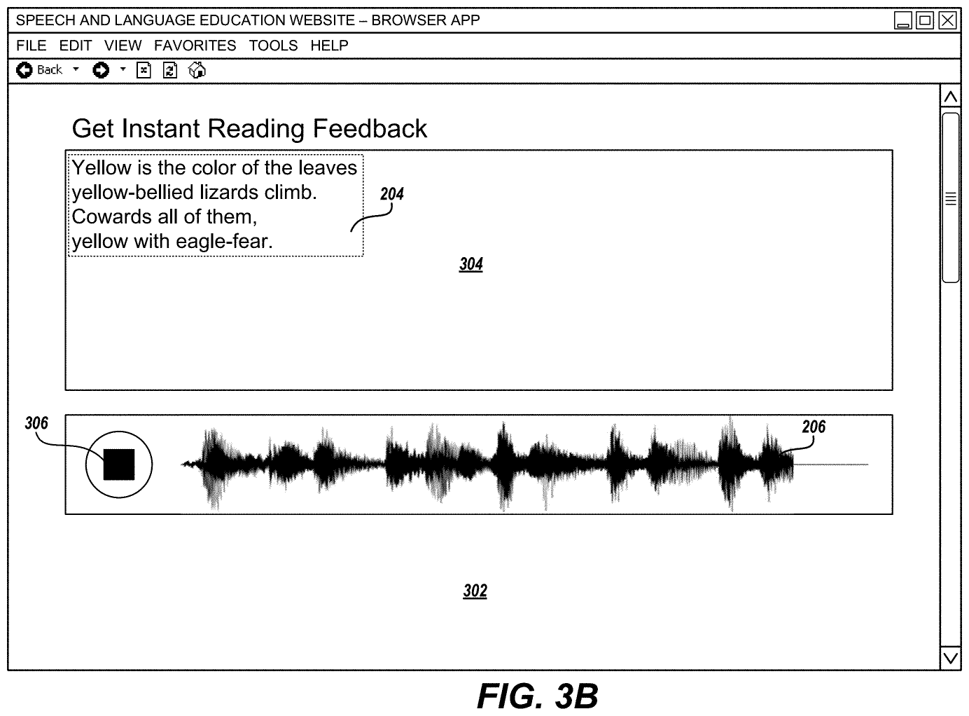

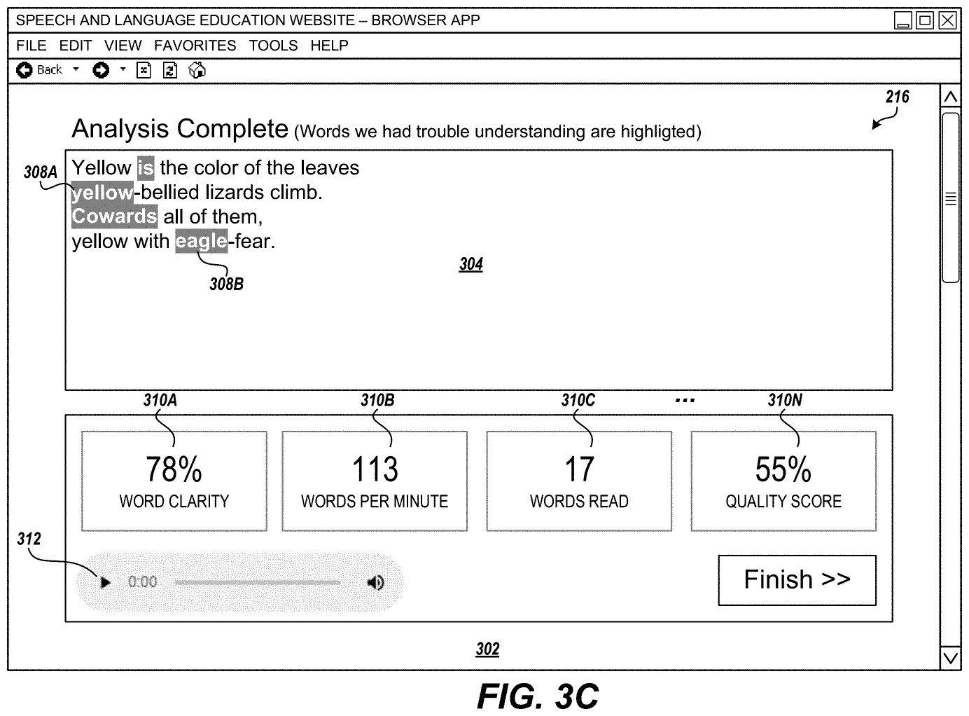

The user 104 may utilize the client app 202 to receive a “target text” 204 from the user 104 comprising an arbitrary text which the user will attempt to read. The target text 204 may come from a variety of sources, such as a form field in a web application, a user-provided document (e.g. an e-book), or data from an AR device which has been processed through Optical Character Recognition (OCR). One advantage of the described reading evaluation service 102 is its ability to receive target texts which are provided naturally from a wide range of inputs, rather than solely pre-defined texts which have been tailored to the application. For example, as shown in FIGS. 3A and 3B, the client app 202 may comprise a web page 302 containing a text box UI control 304 allowing the entry of the target text 204, e.g., by typing or cutting-and-pasting from and external source by the user 104.

In addition, the user 104 may utilize the client app 202 and audio recording resources of the user device 106, such as a microphone and signal processing hardware built into the device, to record the user 104 attempting to read the target text 204. For example, the web page 302 shown in FIGS. 3A and 3B may further contain a button UI control 306 allowing the user to initiate recording of the user 104 reading the target text 204 aloud. The user may click the button control 306 again to end the recording, and then the entered target text 204 and the “user recording” 206 may be transmitted by the client app 202 to the reading evaluation service 102 over the network(s) 108 for processing. In some embodiments, the target text 204 and user recording 206 may be transmitted to the reading evaluation service 102 utilizing the HTTP protocol, such as through a REST API.

Returning to FIG. 2, the reading evaluation service 102 may comprise a read-to-text engine 208. The read-to-text engine 208 processes the user inputs to assess relevant differences between the speech in the user recording 206 and the target text 204 that the user 104 attempted to read and generates feedback for the user. In some embodiments, the read-to-text engine 208 may represent a server-side script or web service module executing in the cloud computing resources of the reading evaluation service 102. The read-to-text engine 208 may be developed in a web application framework, such as the open-source Flask framework, and provide a REST API over HTTP for communication with the client app 202. In alternative embodiments, some or all of the read-to-text engine 208 may be implemented in client app 202 executing on the user device 106.

According to embodiments, the read-to-text engine 208 receives the target text 204 from the client app 202 on the user device 106 over the network(s) 108. In some embodiments, the read-to-text engine 208 then performs input sanitization of the received target text 204. The ability of the reading evaluation service 102 presented herein to assess reading performance of arbitrary natural-language input texts raises several challenges. For example, if a user 104 is reading a poem, heavy use of line-breaks and punctuation can lead to errors in comparing the output of a speech-to-text service with the provided text. To improve the comparison, the received target text 204 is normalized and stripped of phonetically irrelevant information to produce a “target ground truth.” For example, numerical data such as the string “15” may be converted to “fifteen”, and hyphenated words such as “cyber-security” may be normalized to “cyber security.” In addition, punctuation, superfluous spacing, line breaks, and the like may be removed. Table 1 provides an example of a target text 204 and its corresponding sanitized ground truth text.

TABLE 1

| | |
|---|---|
| Target | Yellow is the color of the leaves |
| Text: | yellow-bellied lizards climb. |
| | Cowards all of them, |
| | yellow with eagle-fear. |
| Target | yellow is the color of the leaves |
| Ground | yellow bellied lizards climb cowards |
| Truth: | all of them yellow with eagle fear |

In further embodiments, a ground truth text may be generated via a “round trip” through the speech-to-text service 110. For example, the read-to-text engine 208 may send the target text 204 to a text-to-speech function provided by and/or corresponding to the speech-to-text service 110 to generate a “known good audio recording.” The known good audio recording is then sent back through the speech-to-text service 110 to generate the ground truth text that would be expected from the conversion of a perfect user recording.

In addition to generating the ground truth text from the target text 204, the read-to-text engine 208 utilizes the speech-to-text service 110 to generate a “user speech hypothesis” from the user recording 206 for comparison to the ground truth text. For example, the read-to-text engine 208 may forward the user recording 206 received from the client app 202 to the speech-to-text service 110 over the network(s) 108 via a third-party API 212 associated with the speech-to-text service, such as a web service call. The speech-to-text service 110 may convert the speech contained in the user recording 206 to text then return the user speech hypothesis 214 from the conversion to the read-to-text engine 208 via the third-party API 212. In further embodiments, the read-to-text engine 208 may send the user recording 206 to multiple speech-to-text services 110 through associated third-party APIs 212 and utilize a combination of the generated user speech hypotheses 214 to improve overall accuracy of the comparison.

In some embodiments, prior to sending the user recording 206 to the speech-to-text service 110, the read-to-text engine 208 may perform pre-processing of the user recording. For example, the user recording 206 may be analyzed to determine if the recorded audio has no sound or low volume (e.g., below a certain average or peak amplitude) or the recording is significantly shorter or longer than would be reasonably expected. In addition, the read-to-text engine 208 may crop the user recording to contain the relevant audio or remove extraneous noise, as well as perform any format conversion and/or compression required by the speech-to-text service 110. In further embodiments the read-to-text engine 208 may generate metadata from the target text 204 and/or the target ground truth to provide to the speech-to-text service 110 to increase conversion accuracy. For example, the read-to-text engine 208 may extract groups of words (n-grams) from the target text and feed them to the speech-to-text service 110 through the third-party API 212 to serve as a vocabulary corpus of expected priors to the speech-to-text conversion. In some embodiments, the n-grams may comprise two-word pairs (bi-grams).

Once a ground truth text and user speech hypothesis 214 have been generated from the user inputs, the read-to-text engine 208 performs a comparison of the ground truth text and user speech hypothesis in order to identify the quality and accuracy of the user's reading of the target text 204. According to embodiments, the user speech hypothesis 214 and ground truth text are synchronized to identify individual errors in the reading by type of error and location relative to the ground truth text while keeping the entire reading in context. For example, if the user 104 has skipped a word or sentence in the reading, the read-to-text engine 208 must both recognize this error and determine where the user resumed speaking with respect to the ground truth text. Similarly, if the user 104 has read the word “you're” as “you”, this is an incorrect match and should be reported as an error. However, if a user has read the word “eatin” and the speech-to-text engine has reported that as “eatin” this is not an error, despite the missing apostrophe. Filler words, such as “ah,” “oh,” “um,” and the like that don't appear in the target text 204 may also be flagged as a particular type of error.

In further embodiments, the read-to-text engine 208 may identify long-pauses between individual words in the reading or reading-speed variability in particular sub-passages of the target text 204 to flag words or passages that may have been difficult for the user 104 to read. For example, the user speech hypothesis 214 generated by the speech-to-text service 210 may be accompanied by transcript data including the start and end timing of each word in the converted text. From this transcript data, pauses and/or reading-speed variability over words or passages may be computed and utilized to identify specific types of errors.

The identified errors may then be encoded into the ground truth text to produce a “processing output diff.” For example, Table 2 provides an example of a user speech hypothesis 214 returned from the speech-to-text service 110 and synchronized with the target ground truth from Table 1 to produce a processing output diff.

TABLE 2

| | |
|---|---|
| User Speech | yellow the color of the leaf yerba bellied lizards climb |
| Hypothesis: | cows all of them yellow with fear |
| Processing | yellow <err>is</err> the color of the |
| Output Diff: | <err>leaves</err> <err>yellow</err> bellied lizards |
| | climb<err>cowards</err> all of them yellow with |
| | <err>eagle</err> fear |

Additionally, the read-to-text engine 208 generates a set of “user performance metrics” regarding the quality and accuracy of the reading based on the comparison that may be useful to the user 104 in continued training and education. For example, the read-to-text engine 208 may normalize each of the user speech hypothesis 214 and target ground truth and then computes a word error rate (“WER”) based on a minimum-edit distance (Levenshtein distance) between the two normalized texts. The word error rate can then be utilized to compute an overall metric for quality and accuracy of the reading, e.g. a “quality” or “word clarity” score that provides a comparable score for future readings by the same user 104 or between the user and other users. Other user performance metrics that may be computed include total word count from the target ground truth, total words read from the user speech hypothesis, time of reading, and the like.

Because of the arbitrary nature of the initial target text 204, computing a comparable overall quality/accuracy may require the relative reading difficulty of the text to be determined. The read-to-text engine 208 may compute one or more standard reading difficulty metrics for the target text 204 to be utilized in computing the quality score or to accompany the user performance metrics in order to better communicate to both the user 104 and educators/clinicians 120 the relative complexity of the passage that was read. In another embodiment, the reading difficulty metric may be computed from the target text 204 before the user recording 206 is made at user device 106 and displayed to the user 104 in order to give the user an expected difficulty of reading before the user initiates the recording.

For example, the read-to-text engine 208 may leverage the Flesh-Kincaid readability formula, a widely used readability metric that rates passages as a grade level score, for computation of a reading difficulty metric. Other readability metrics utilized may include Gunning-Fog, Coleman-Liau, Dale-Chall, ARI, Linsear Write, SMOG, and Spache. While many of these models depend on longer texts, the read-to-text engine 208 may utilize metamodels to compute the reading difficulty metric for shorter passages (e.g., less than 100 words) that combine these readability metrics into a more communicative score. In particular, the read-to-text engine 208 may weight lexico-semantic features like syllables-per-word and phoneme n-gram frequency relative to the general corpus in order to better identify passages which may be difficult to read aloud.

Once the processing output diff has been generated with correctly designated errors, the read-to-text engine 208 may then utilize the processing output diff to generate a visual display of the identified reading errors for the user 104, referred to herein as the “user result diff.” First, the processing output diff is adjusted to be expressible in terms of the target text 204 by correctly re-populating punctuation, hyphenation, and other phonetically irrelevant data back into the user result diff. Then the identified errors from the processing output diff are overlaid on the user result diff by identifying the beginning and end of a specific occurrence of an erroneous word or phrase in the user result diff and using these offsets to visually highlight the error. For example, the highlighting may comprise changing the color and/or character of missing, mis-pronounced, or unclearly pronounced words or phrases as well as grammatical, timing, and other errors identified in the processing output diff. In further embodiments, different types of errors may be identified utilizing different highlighting techniques. Table 3 shows a user result diff generated from the processing output diff shown in Table 2 overlaid on the target text from Table 1. According to some embodiments, the highlighting may be accomplished for display in the client app 202 by adding HTML, or XML tags to the user result diff text that are transformed into the appropriate visual highlighting by the client app (i.e. a browser).

TABLE 3

| | |
|---|---|
| Processing | yellow <err>is</err> the color of the |
| Output | <err>leaves</err> <err>yellow</err> bellied lizards |
| Diff: | climb<err>cowards</err> all of them yellow with |
| | <err>eagle</err> fear |
| User | Yellow is the color of the leaves |
| Result | yellow-bellied lizards climb. |
| Diff: | Cowards all of them, |
| | yellow with eagle-fear. |

The read-to-text engine 208 may then combine the user result diff and the user performance metrics into a visual report, referred to herein as the “user reading report” 216, and return the report to the client app 202 for display to the user 104. In some embodiments, the user reading report 216 may be provided to the client app 202 from the read-to-text engine 208 via JSON through a REST API. The client app 202 may then display the user reading report 216 to the user 104. For example, as shown in FIG. 3C, the user reading report 216 may contain the text box control 304 containing the original target text 204 with the identified erroneous words of the reading shown with appropriate highlighting, as further shown at 308A and 308B. The user reading report 216 may further show the user performance metrics, such as a word clarity score 310A, reading speed 310B, total words read 310C, an overall quality score 310N, and the like, as further shown in FIG. 3C.

According to further embodiments, the display of the user reading report 216 may contain an audio playback control 312 that allows the user 104 to replay the user recording 206 made from the reading to evaluate the feedback in the user reading report 216. In some embodiments, the display of the user result diff in the text box control 304 may be augmented to show the associated position corresponding to the current time index in the playback of the user recording 206.

According to further embodiments, the read-to-text engine 208 may store the user reading reports 216 generated for users 104 in a database 218 or other data storage facility in the cloud computing resources of the reading evaluation service 102. The reading evaluation service 102 may further support an educator/clinician app 220 executing on educator/clinician computing device(s) 122 that allows educator/clinicians 120 access to user reading reports 216 of associated users 104, e.g., students and/or clients. The educator/clinician app 220 may be designed to assist educators/clinicians 120 in reviewing the performance of users 104 over time and across many assignments. Metrics from the user reading reports 216 can be filtered and key problem areas (e.g., frequently missed words or struggling students) can be raised for additional attention. In some embodiments, the educator/clinician app 220 may represent a web-based application similar to the client app 202 that accesses the user reading reports 216 in the database 218 through the REST API provided by the read-to-text engine 208. Alternatively or additionally, educators/clinicians 120 may be provided with user reading reports 216 and related summary information for associated users 104 (students/clients) via more traditional communication mechanisms, such as email, as shown at 222 in FIG. 2.

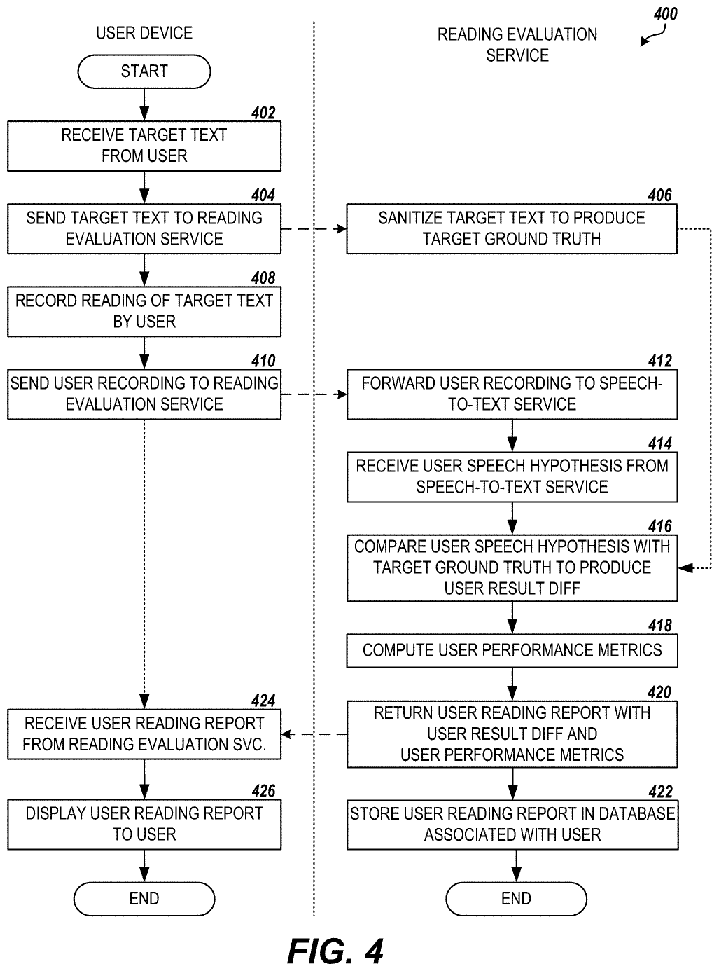

FIG. 4 illustrates one routine 400 for providing reading performance feedback to a user from a voice recording of the user reading an arbitrary text, utilizing the systems and components described herein. For example, the routine 400 may be performed by a combination of the client app 202 executing on a user device 106 and the read-to-text engine 208 executing in the reading evaluation service 102. In other embodiments, the routine 400 may be performed by some combination of the user device 106, the reading evaluation service 102, and/or other computing devices, components, and modules.

The routine 400 begins at step 402, where a target text 204 is received at the user device 106 from the user 104. The target text 204 comprising an arbitrary text which the user will attempt to read. As described herein, the target text 204 may be entered by the user 104 in a form field in a user interface of the client app 202, such as the text box control 304 shown in FIGS. 3A and 3B. In further embodiments, the target text 204 may be received from a user-provided document (e.g. an e-book), from a camera of the user device 106 processed through Optical Character Recognition (OCR), or any combination of these or other text sources.

From step 402, the routine proceeds to step 404, where the target text 204 is sent from the user device 106 to the reading evaluation service 102. This may be accomplished by the client app 202 utilizing a REST API implemented by the read-to-text engine 208. Next, at step 406, the reading evaluation service 102 sanitizes the received target text 204 to produce the target ground truth. According to embodiments, this may include normalizing the target text and stripping out any phonetically irrelevant information, such as punctuation, superfluous spacing, line breaks, and the like.

At step 408, a user recording 206 of the user 104 reading the target text 204 aloud is also received at the user device 106. The client app 202 may utilize the audio recording resources of the user device 106, such as a microphone and signal processing hardware built into the device, to record the user 104 attempting to read the target text 204. As described above in regard to FIGS. 3A and 3B, a web-based UI provided by the client app 202 may provide a button control 306 allowing the user 104 to perform the recording. From step 408, the routine 400 proceeds to step 410, where the user recording 206 is sent from the user device 106 to the reading evaluation service 102, e.g., by the client app 202 utilizing the same or similar REST API of the read-to-text engine 208 as used in step 404 for the target text 204.

Upon receiving the user recording 206, the reading evaluation service 102 may then forward the user recording to the speech-to-text service 110 to convert the recorded audio to text, as shown at step 412. In some embodiments, the read-to-text engine 208 executing in the reading evaluation service may send the received user recording to the speech-to-text service 110 via a third-party API 212, as described above in regard to FIG. 2. In further embodiments, the read-to-text engine 208 may send the user recording 206 to multiple speech-to-text services 110 through associated third-party APIs 212 and utilize a combination of the generated user speech hypotheses 214 to improve overall accuracy of the comparison.

According to some embodiments, prior to forwarding the user recording 206 to the speech-to-text service 110, the read-to-text engine 208 may perform certain pre-processing of the user recording. For example, the user recording 206 may be analyzed to determine if the recorded audio has no sound or low volume (e.g., below a certain average or peak amplitude) or the recording is significantly shorter or longer than would be reasonably expected. In addition, the read-to-text engine 208 may provide metadata generated from the target text 204 and/or the target ground truth to the speech-to-text service 110 to increase conversion accuracy, such as two-word pairs (bi-grams) extracted from the ground truth text. The routine 400 proceeds from step 412 to step 414, where the reading evaluation service 102 receives the decoded text, or user speech hypothesis 214, from the user recording 206 from the speech-to-text service 110.

Next, at step 416, the reading evaluation service 102 compares the target ground truth and user speech hypothesis 214 to produce the user result diff. This may involve the read-to-text engine 208 synchronizing the user speech hypothesis 214 and target ground truth to identify individual errors in the reading by type of error and location relative to the ground truth text to produce the processing output diff. The read-to-text engine 208 may then utilize the processing output diff to generate the user result diff by adjusting the processing output diff to be expressible in terms of the original target text 204 and then overlay the errors identified in the processing output diff on the user result diff by visually highlight the words or phrases in error.

From step 416, the routine 400 proceeds to step 418, where the reading evaluation service 102 computes the user performance metrics regarding the quality and accuracy of the reading based on the comparison to provide additional useful feedback to the user 104. For example, the read-to-text engine 208 may normalize each of the user speech hypothesis 214 and target ground truth and then computes the WER based on a minimum-edit distance between the two normalized texts. The WER may then be utilized to compute an overall metric for quality and accuracy of the reading, e.g. a “quality” or “word clarity” score that provides a comparable score for future readings by the same user 104 or between the user and other users. Other user performance metrics that may be computed include total word count from the target ground truth, total words read from the user speech hypothesis, time of reading, and the like.

The routine 400 proceeds from step 418 to step 420, where the reading evaluation service 102 combines the user result diff from step 416 and the user performance metrics from step 418 to produce a user reading report 216 containing the feedback for the user 104, and returns the report to the user device 106. In some embodiments, this may be accomplished by the client app 202 on the user device 106 requesting the user reading report 216 from the read-to-text engine 208 through a REST API. In some embodiments, in addition to sending the user reading report 216 to the user device 106, the reading evaluation service 102 may store the report in a database associated with an identity or profile of the user 104, as shown at step 422. The user reading reports 216 of users 104 may be subsequently retrieved, reviewed, and/or summarized for associated educators/clinicians 120 through the educator/clinician app 220.

Upon receiving the user reading report 216, the client app 202 may then display the report to the user 104 on a display of the user device 106, as shown at steps 424 and 426. For example, as described above in FIG. 3C, the client app 202 may show a web page 302 containing the user result diff from the user reading report 216 with the identified erroneous words of the reading shown with appropriate highlighting. The web page 302 may also display the user performance metrics, such as a word clarity score 310A, reading speed 310B, total words read 310C, an overall quality score 310N, and the like, as further shown in FIG. 3C. From step 426, the routine 400 ends.

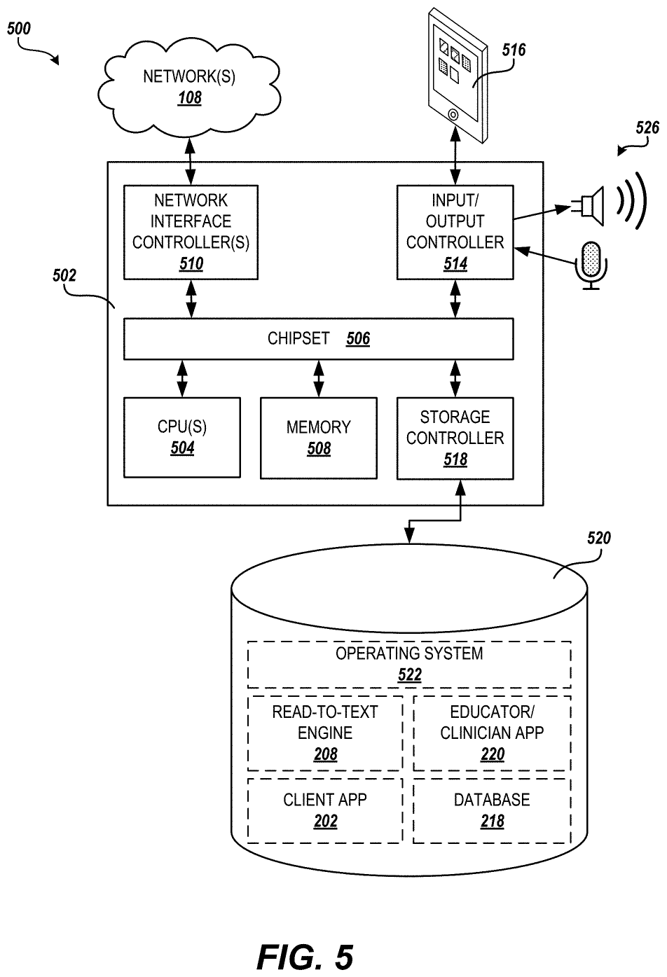

FIG. 5 shows an example computer architecture 500 for a computing device 502 capable of executing software components described herein for providing reading performance feedback to a user from a voice recording of the user reading an arbitrary text. The computer architecture 500 shown in FIG. 5 illustrates a mobile device, desktop computer, laptop, workstation, server, or other computing device, and may be utilized to execute any aspects of the software components presented herein described as executing on the user device 106, the educator/clinician computing device 122, in the reading evaluation service 102, or other computing platform. The computing device 502 may include a baseboard, or “motherboard,” which is a printed circuit board to which a multitude of components or devices may be connected by way of a system bus or other electrical communication paths.

In some embodiments, one or more central processing units (“CPUs”) 504 operate in conjunction with a chipset 506. The CPU(s) 504 may be standard programmable processors that perform arithmetic and logical operations necessary for the operation of the computing device 502. The chipset 506 provides an interface between the CPU(s) 504 and the remainder of the components and devices on the baseboard. The chipset 506 may provide an interface to a memory 508. The memory 508 may include a random-access memory (“RAM”) used as the main memory in the computing device 502. The memory 508 may further include a computer-readable storage medium such as a read-only memory (“ROM”) or non-volatile RAM (“NVRAM”) for storing basic routines that that help to startup the computing device 502 and to transfer information between the various components and devices. The ROM or NVRAM may also store other software components necessary for the operation of the computing device 502 in accordance with the embodiments described herein.

According to various embodiments, the computing device 502 may operate in a networked environment using logical connections to remote computing devices through one or more networks, such as a Wi-Fi network, a LAN, a WAN, a cellular data network, the Internet or “cloud,” or any other networking topology known in the art that connects the computing device 502 to other, remote computers or computing systems, including the network(s) 108 described herein in regard to FIG. 1. The chipset 506 may include functionality for providing network connectivity through one or more network interface controllers (“NICs”) 510, such as a gigabit Ethernet adapter, a Wi-Fi adapter, or a cellular-data adapter. It should be appreciated that any number of NIC(s) 510 may be present in the computing device 502, connecting the computer to other types of networks and remote computer systems beyond those described herein.

The computing device 502 may also include an input/output controller 514 for interfacing with various external devices and components, such as a touchscreen display 516 of a mobile device, for example. The input/output controller 514 may further interface the computing device 502 with audio recording and playback resources 526, such as a speaker and microphone, along with an associated DSP circuit. Other examples of external devices that may be interfaced to the computing device 502 by the input/output controller 514 include, but are not limited to, standard user interface components of a keyboard, mouse, and display, a touchpad, an electronic stylus, a computer monitor or other display, a video camera, a printer, an external storage device, such as a Flash drive, and the like. According to some embodiments, the input/output controller 514 may include a USB controller.

The computing device 502 may be connected to one or more mass storage devices 520 that provide non-volatile storage for the computer. Examples of mass storage devices 520 include, but are not limited to, hard disk drives, solid-state (Flash) drives, optical disk drives, magneto-optical disc drives, magnetic tape drives, memory cards, holographic memory, or any other computer-readable media known in the art that provides non-transitory storage of digital data and software. The mass storage device(s) 520 may be connected to the computing device 502 through a storage controller 518 connected to the chipset 506. The storage controller 518 may interface with the mass storage devices 520 through a serial attached SCSI (“SAS”) interface, a serial advanced technology attachment (“SATA”) interface, a fiber channel (“FC”) interface, or other standard interface for physically connecting and transferring data between computers and physical storage devices.

The mass storage device(s) 520 may store system programs, application programs, other program modules, and data, which are described in greater detail in the embodiments herein. According to some embodiments, the mass storage device(s) 520 may store an operating system 522 utilized to control the operation of the computing device 502. In some embodiments, the operating system 522 may comprise the IOS® or ANDROID™ mobile device operating systems from Apple, Inc. and Google, LLC, respectively. In further embodiments, the operating system 522 may comprise the WINDOWS® operating system from MICROSOFT Corporation of Redmond, Wash. In yet further embodiments, the operating system 522 may comprise the LINUX operating system, the WINDOWS® SERVER operating system, the UNIX operating system, or the like. The mass storage device(s) 520 may store other system or application program module and data described herein, such as the read-to-text engine 208, the client app 202, the database 218, or the educator/clinician app 220, utilized by the reading evaluation system and described in the various embodiments. In some embodiments, the mass storage device(s) 520 may be encoded with computer-executable instructions that, when executed by the computing device 502, perform the routine 400 described in regard to FIG. 4 for providing reading performance feedback to a user from a voice recording of the user reading an arbitrary text.

It will be appreciated that the computer architecture 500 may not include all of the components shown in FIG. 5, may include other components that are not explicitly shown in FIG. 5, or may utilize an architecture completely different than that shown in FIG. 5. For example, the CPU(s) 504, memory 508 and mass storage devices 520, and NIC(s) 510 of the computer architecture 500 may represent components of a System-on-a-Chip (“SoC”) integrated circuit utilized in a handheld video streaming device or smartphone, virtualized resources from any number of server computers or computing devices, or generic processing resources, storage resources, and communication resources of a cloud-based computing system, with the chipset 506 representing communication interlinks between the processing, storage, communication, and other computing resources in the cloud-based computing system. It is intended that all such computing architectures be included within the scope of this application.

Based on the foregoing, it will be appreciated that technologies for providing reading performance feedback to a user from a voice recording of the user reading an arbitrary text are presented herein. The above-described embodiments are merely possible examples of implementations set forth for a clear understanding of the principles of the present disclosure. Many variations and modifications may be made to the above-described embodiments without departing substantially from the spirit and principles of the present disclosure. All such modifications and variations are intended to be included within the scope of the present disclosure, and all possible claims to individual aspects or combinations and sub-combinations of elements or steps are intended to be supported by the present disclosure.

The logical steps, functions or operations described herein as part of a routine, method or process may be implemented (1) as a sequence of processor-implemented acts, software modules or portions of code running on a controller or computing system and/or (2) as interconnected machine logic circuits or circuit modules within the controller or other computing system. The implementation is a matter of choice dependent on the performance and other requirements of the system. Alternate implementations are included in which steps, operations or functions may not be included or executed at all, may be executed out of order from that shown or discussed, including substantially concurrently or in reverse order, depending on the functionality involved, as would be understood by those reasonably skilled in the art of the present disclosure.

It will be further appreciated that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

What is claimed is:

1. A method comprising steps of:
receiving, by a reading evaluation service, a target text comprising a text passage that a user intends to read;
receiving, by the reading evaluation service, a user recording comprising an audio recording of the user reading the target text aloud;
converting the user recording to a user speech hypothesis comprising text corresponding to speech recognized in the audio recording;
comparing, by the reading evaluation service, the user speech hypothesis to the target text to generate reading performance feedback comprising relevant differences between the speech in the user recording and the target text; and
displaying the reading performance feedback to the user.

2. The method of claim 1, further comprising steps of:
upon receiving the target text, sanitizing, by the reading evaluation service, the target text to produce a target ground truth, wherein comparing the user speech hypothesis to the target text comprises synchronizing the user speech hypothesis with the target ground truth.

3. The method of claim 2, wherein sanitizing the target text to produce the target ground truth comprises normalizing the target text and removing phonetically irrelevant information.

4. The method of claim 1, wherein generating the reading performance feedback comprises identifying individual word or phrase errors in the user speech hypothesis based on the comparison to the target text.

5. The method of claim 4, wherein displaying the reading performance feedback to the user comprises displaying the target text to the user with the individual word or phrase errors visually highlighted.

6. The method of claim 1, wherein generating the reading performance feedback comprises computing user performance metrics regarding the reading of the target text by the user, the user performance metrics being displayed to the user with the reading performance feedback.

7. The method of claim 1, wherein the target text is received from the user by a client app executing on a user device and transmitted to the reading evaluation service over one or more networks connecting the user device to the reading evaluation service, and wherein the displaying the reading performance feedback to the user comprises sending, by the reading evaluation service, the reading performance feedback to client app over the one or more networks, the client app displaying the reading performance feedback on a display of the user device.

8. The method of claim 7, wherein the user recording is obtained by the client app using audio recording resources of the user device and transmitted by the client app to the reading evaluation service over the one or more networks.

9. The method of claim 1, wherein converting the user recording to a user speech hypothesis comprises forwarding, by the reading evaluation service, the user recording to a speech-to-text service over one or more networks connecting the reading evaluation service to the speech-to-text service, and receiving, by the reading evaluation service, the user speech hypothesis from the speech-to-text service over the one or more networks.

10. The method of claim 9, further comprising the steps of:
generating, by the reading evaluation service, metadata from the target text; and
providing, by the reading evaluation service, the metadata to the speech-to-text service in order to increase conversion accuracy.

11. A non-transitory computer-readable medium encoded with computer-executable instructions that, when executed by processing resources of a computing system; cause the computing system to:
in response to receiving a target text from a user device comprising a text passage that a user of the user device intends to read, sanitizing the target text to produce a target ground truth;
in response to receiving a user recording comprising an audio recording of the user reading the target text aloud, converting the user recording to a user speech hypothesis comprising text corresponding to speech recognized in the audio recording;
comparing the user speech hypothesis to the target ground truth to generate reading performance feedback comprising relevant differences between the speech in the user recording and the target ground truth; and
sending the reading performance feedback to the user device for display to the user.

12. The non-transitory computer-readable medium of claim 11, wherein sanitizing the target text to produce the target ground truth comprises normalizing the target text and removing phonetically irrelevant information.

13. The non-transitory computer-readable medium of claim 11, wherein generating the reading performance feedback comprises synchronizing the target ground truth with the user speech hypothesis to identify individual word or phrase errors in the user speech hypothesis based on the comparison to the target ground truth, the identified individual word or phrase errors displayed to the user on the user device by highlighting corresponding words or phrases in a display of the target text.

14. The non-transitory computer-readable medium of claim 11, encoded with further computer-executable instructions that cause the computing system to compute user performance metrics regarding the reading of the target text by the user in the user speech hypothesis, the user performance metrics being displayed to the user on the user device with the reading performance feedback.

15. The non-transitory computer-readable medium of claim 11, encoded with further computer-executable instructions that cause the computing system to store the reading performance feedback in a database associated with an identity of the user, the reading performance feedback subsequently retrievable by an educator/clinician associated with the user via a remote computing device.

16. A system comprising:
a client app executing on a user device and configured to
receive a target text from a user of the user device, the target text comprising a text passage that the user intends to read,
utilize audio recording resources of the user device to create a user recording comprising an audio recording of the user reading the target text aloud,
transmit the target text and user recording to a reading evaluation service over one or more networks,
receive reading performance feedback from the reading evaluation service, and
display the reading performance feedback to the user on the user device; and
the reading evaluation service connected to the user device over the one or more networks and configured to
receive the target text and user recording from the client app,
sanitize the target text to produce a target ground truth,
convert the user recording to a user speech hypothesis comprising text corresponding to speech recognized in the audio recording,
compare the user speech hypothesis to the target ground truth to generate the reading performance feedback comprising relevant differences between the speech in the user recording and the target ground truth, and
transmit the reading performance feedback to the client app over the one or more networks.

17. The system of claim 16, wherein generating the reading performance feedback comprises identifying individual word or phrase errors in the user speech hypothesis based on the comparison to the target ground truth.

18. The system of claim 17, wherein the client app is further configured to display the target text to the user with the identified individual word or phrase errors visually highlighted.

19. The system of claim 16, wherein the reading evaluation service is further configured to compute user performance metrics regarding the reading of the target text by the user, the user performance metrics included in the reading performance feedback transmitted to the client app and displayed to the user.

20. The system of claim 16, wherein converting the user recording to a user speech hypothesis comprises forwarding the user recording to a speech-to-text service over the one or more networks and receiving the user speech hypothesis from the speech-to-text service.
